(19) United States
(12) Patent Application Publication
(10) Pub. No.: US 2026/0299212 A1
(43) Pub. Date: Oct. 1, 2026

(54) PHOTONIC QUANTUM SWITCH

(71) Applicant: Cisco Technology, Inc., San Jose, CA (US)

(72) Inventors: Jiapeng Zhao, Kenmore, WA (US); Reza Nejabati, Los Angeles, CA (US); Ramana Rao V R Kompella, Foster City, CA (US); Galan Andrew Moody, Goleta, CA (US)

(21) Appl. No.: 19/317,663

(22) Filed: Sep. 3, 2025

Related U.S. Application Data
(60) Provisional application No. 63/779,606, filed on Mar. 28, 2025.

(51) Int. Cl. G02B 6/35; G02F 1/39

(52) U.S. Cl. CPC G02B 6/35; G02F 1/39

(57) ABSTRACT

An example embodiment provides a photonic quantum switch with entanglement conversion. The photonic quantum switch provides scalability and compactness, and enables greater than 1 GHz/sub-nanosecond switching speeds. A method includes: receiving photons of an input entangled state at a quantum switch including a plurality of outputs; converting the photons to entanglement components compatible with a plurality of optical switches of the quantum switch; receiving a different entanglement component at each of the plurality of optical switches and routing the different entanglement component to an optical switch output of each of the plurality of optical switches; and producing entangled photons in an output entangled state for a corresponding one of the plurality of outputs of the quantum switch based on corresponding entanglement components from outputs of the plurality of optical switches.

### CROSS-REFERENCE TO RELATED APPLICATION

This application claims priority to U.S. Provisional Patent Application Ser. No. 63/779,606, entitled “Photonic Quantum Switch” and filed on Mar. 28, 2025, the entirety of which is incorporated herein by reference.

### TECHNICAL FIELD

The present disclosure relates to quantum switches.

### BACKGROUND

Compared to micro-electromechanical systems (MEMS), local oxidation of silicon (LCOS), or optomechanical switches, photonic switches are naturally more compact. However, photonic switches suffer more loss, crosstalk, and a worse uniformity. In addition, current photonic switches cannot preserve quantum entanglement during reconfiguration.

### BRIEF DESCRIPTION OF THE DRAWINGS

FIG. 1 is a block diagram of an example quantum network architecture, according to an example embodiment.

FIG. 2 is a block diagram of an example photonic quantum switch, according to an example embodiment.

FIG. 3A is a block diagram of an input quantum state converter (QSC) for converting a polarization entanglement state for a switch path, according to an example embodiment.

FIG. 3B is a block diagram of a input quantum state converter (QSC) for converting a time-bin entanglement state for a switch path, according to an example embodiment.

FIG. 3C is a block diagram of an input quantum state converter (QSC) for converting a frequency-bin entanglement state for a switch path, according to an example embodiment.

FIG. 4A is a block diagram of an output quantum state converter (QSC) for converting from a switch path to a polarization entanglement state, according to an example embodiment.

FIG. 4B is a block diagram of an output quantum state converter (QSC) for converting from a switch path to a time-bin entanglement state, according to an example embodiment.

FIG. 4C is a block diagram of an output quantum state converter (QSC) for converting from a switch path to a frequency-bin entanglement state, according to an example embodiment.

FIG. 5 is a block diagram of pluggable modules for input quantum state converters (QSCs), according to an example embodiment.

FIG. 6 is a block diagram of performing entanglement conversion using the photonic quantum switch, according to an example embodiment.

FIG. 7 illustrates a flowchart of a generalized method for switching entangled photons in a photonic quantum switch, according to an example embodiment.

FIG. 8 illustrates a hardware block diagram of a computing device configured to perform functions associated with operations discussed herein, according to an example embodiment.

### DETAILED DESCRIPTION

### Overview

An example embodiment provides a photonic quantum switch with entanglement conversion. The photonic quantum switch provides scalability and compactness, and enables greater than 1 GHz/sub-nanosecond switching speeds.

In one embodiment, a method is provided that includes: receiving photons of an input entangled state at a quantum switch including a plurality of outputs; converting the photons to entanglement components compatible with a plurality of optical switches of the quantum switch; receiving a different entanglement component at each of the plurality of optical switches and routing the different entanglement component to an optical switch output of each of the plurality of optical switches; and producing entangled photons in an output entangled state for a corresponding one of the plurality of outputs of the quantum switch based on corresponding entanglement components from outputs of the plurality of optical switches.

### Example Embodiments

An example embodiment provides a photonic quantum switch with entanglement conversion. Metrics in switch design include: switch time (e.g., the time to finish one reconfiguration of a switch), switch time jitter (e.g., the uncertainty in switch time), dimension (e.g., number of ports supported by a switch), insertion loss (e.g., the reduction of photons after the switch), optical crosstalk (e.g., the number of photons going to the wrong port), switch crosstalk (e.g., an impact of switching on adjacent channels), wavelength range (e.g., the working wavelength range of the switch), uniformity (e.g., how identical the different ports are), qubit fidelity (e.g., how much change in the quantum state after reconfiguration of the switch), manufacturability (e.g., whether the process is mature and the platform can be scaled up), power consumption (e.g., how much power costs for each reconfiguration and the static power of the switch), and/or footprint (e.g., size of the switch). The photonic quantum switch of the example embodiment provides scalability and compactness, and enables greater than 1 GHz/sub-nanosecond switching speeds.

In an embodiment, the photonic quantum switch comprises converters and a plurality of parallel optical switches. A first converter converts photons of an input entangled state to entanglement components compatible with path states of the optical switches. The plurality of parallel optical switches each receives a different entanglement component in a path state from the first converter and switches the entanglement component to a directed optical switch output. A second converter receives corresponding entanglement components from corresponding outputs of the optical switches and produces an output entangled state for the photons.

In an embodiment, the photonic quantum switch may convert between entangled states. In this case, the second converter produces an output entangled state different than the input entangled state to convert the photons from the input entangled state to the output entangled state.

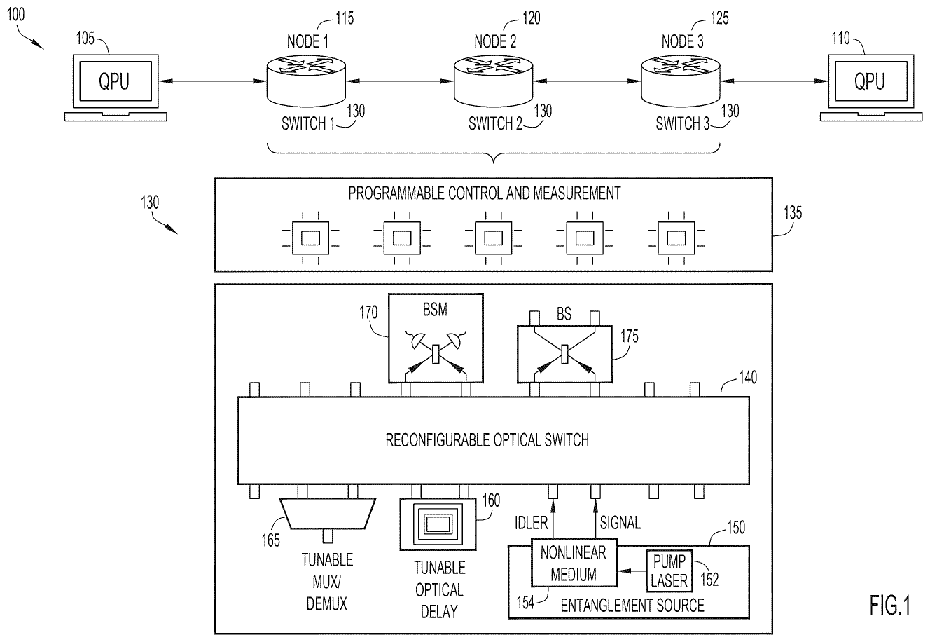

FIG. 1 is a block diagram of an example quantum network architecture 100, according to an example embodiment. Quantum network architecture 100 includes quantum processors (QPUs) 105, 110, and a series of nodes 115 (Node 1), 120 (Node 2), 125 (Node 3). QPUs 105, 110 communicate (or transfer information) with each other over nodes 115, 120, 125. However, quantum network architecture 100 may include any quantity of QPUs and nodes.

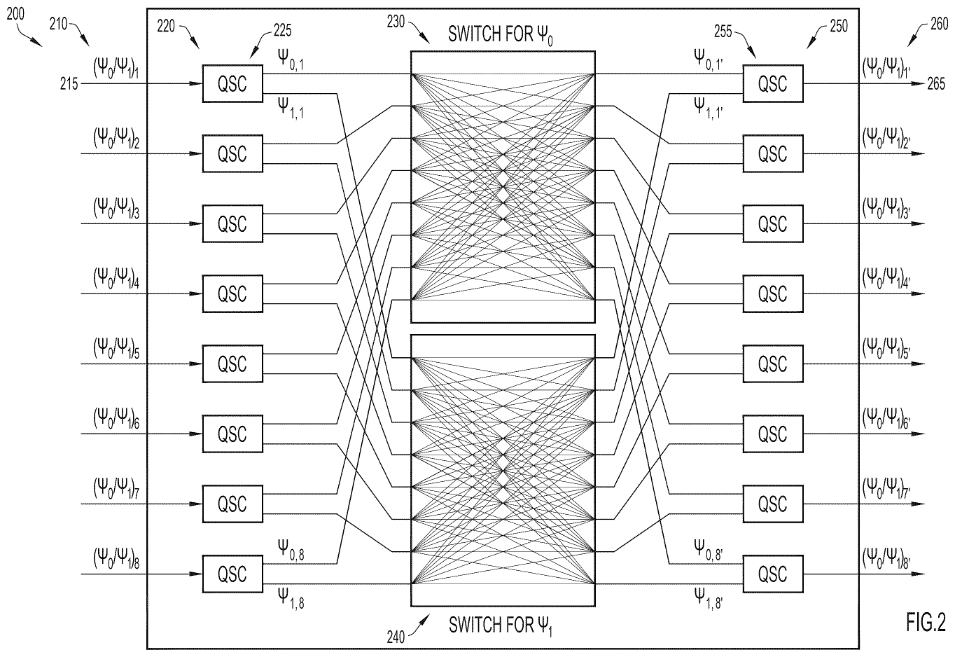

Each node 115, 120, 125 of quantum network architecture 100 includes a quantum switch 130 (Switch 1, Switch 2, Switch 3), preferably a top of rack quantum switch. Quantum switch 130 includes a programmable control and measurement unit 135, and a reconfigurable optical switch 140. The programmable control and measurement unit 135 may be implemented by any conventional or other control and/or measurement mechanisms to control operation of a corresponding node (including reconfigurable optical switch 140). Reconfigurable optical switch 140 includes a photonic quantum switch 200 (FIG. 2) according to example embodiments as described below.

Reconfigurable optical switch 140 may be coupled to various components to perform operations. For example, the reconfigurable optical switch may be coupled to a conventional or other entanglement source 150 to generate entangled photons, a conventional or other tunable optical delay 160 to provide desired delay for optical signals, a conventional or other tunable optical multiplexer/demultiplexer 165 to combine and separate optical signals, a conventional or other Bell State Measurement (BSM) unit 170 to perform measurements of qubits or quantum signals, and a conventional or other Bell State (BS) unit 175 to generate qubits or quantum signals in a Bell State. By way of example, entanglement source 150 includes a pump laser 152 that provides laser pulses to a non-linear medium 154 to generate signal and idler (entangled) photons (e.g., via a spontaneous parametric down-conversion (SPDC) technique).

With continued reference to FIG. 1, FIG. 2 is a block diagram of an example photonic quantum switch 200 (or switching apparatus or system) of reconfigurable optical switch 140, according to an example embodiment. Photonic quantum switch 200 includes a series of input ports 210 to receive corresponding inputs 215, a series 220 of input quantum state converters (QSCs) 225 coupled to input ports 210, optical switches 230, 240 coupled to input QSCs 225, a series 250 of output quantum state converters (QSCs) 255 coupled to optical switches 230, 240, and a series of output ports 260 coupled to output QSCs 255 to provide corresponding outputs 265. Inputs 215 include entangled photons representing qubits that are defined as a combination of states which may be expressed as |Ψ>=α|Ψ₀>+βΨ₁>(e.g., inputs (Ψ₀/Ψ₁)₁, (Ψ₀/Ψ₁)₂, (Ψ₀/Ψ₁)₃, (Ψ₀/Ψ₁)₄, (Ψ₀/Ψ₁)₅, (Ψ₀/Ψ₁)₆, (Ψ₀/Ψ₁)₇, and (Ψ₀/Ψ₁)₈ as viewed in FIG. 2).

An input QSC 225 is a state-to-path (S2P) converter that converts any of the input encoded (or entangled) states to path (or optical) encoding compatible with optical switches 230, 240 depending on the input type of entanglement as described below. Each input QSC 225 (or S2P converter) converts an input qubit encoding modality to path-encoding states in one of a photonic transverse electric (TE) or photonic transverse magnetic (TM) waveguide modes.

Each input QSC 225 receives a corresponding input 215 and converts the input encoded (or entangled) states to path (or optical) encoding compatible with optical switches 230, 240. Further, components of the entangled photons (e.g., a photon of state Ψ₀, a photon of state Ψ₁) are directed from input QSC 225 to a different corresponding optical switch 230, 240. For example, input QSC 225 may perform polarization qubit conversion, where polarization-entangled photons (or qubits) have the polarization state of one photon correlated with the polarization state of another photon. In this case, photons of H (Ψ₀) (horizontal polarization) and V (Ψ₁) (vertical polarization) polarization states are separated and provided to respective optical switches 230, 240.

Further, input QSC 225 may perform time-bin qubit conversion, where time-bin entangled photons (or qubits) are correlated based on a time difference of the photons (e.g., difference in time of traversals of different paths by the photons in an interferometer). In this case, photons of early (Ψ₀) and late (Ψ₁) time bins (or time intervals) are separated and provided to respective optical switches 230, 240.

In addition, input QSC 225 may perform frequency-bin qubit conversion, where frequency-bin entangled photons (or qubits) have a frequency bin (or frequency range) of a signal photon correlated with a frequency bin (or frequency range) of an idler photon. In this case, photons of low frequency (Ψ₀) and high frequency (Ψ₁) states are separated and provided to respective optical switches 230, 240.

In an embodiment, input QSC 225 may convert between TE and TM modes for consistency and compatibility with optical switches 230, 240 (e.g., convert a separated component from TM mode to TE mode, convert a separated component from TE mode to TM mode, etc.). For example, optical switches 230, 240 may each be compatible with a same mode, where one of the separated components resides in another mode and may be converted.

Optical switches 230, 240 may be implemented by any conventional or other photonic switch, such as a microring resonator or a Mach Zehnder interferometer (MZI). The switch topology may include any conventional or other cross-bar or Benes topology, and may utilize various switching mechanisms (e.g., micro-electromechanical systems (MEMS), thermo-optic, electro-optic, magneto-optic, etc.). Optical switches 230, 240 route (or switch) the corresponding separated components (e.g., photons of state Ψ₀, photons of state Ψ₁) from input QSCs 225 to appropriate output ports of those switches. Programmable control and measurement unit 135 may configure the optical switches for the desired routing. By way of example, optical switches 230, 240 are each an eight (input) by eight (output) optical switch that can route any input to any output of that switch, and may be arranged in parallel. However, the optical switches may accommodate any quantities of inputs and outputs, may receive inputs on any input ports, may route components to the same or different output ports (depending on the configuration), and may be arranged in any fashion (e.g., serial, parallel, etc.). Further, optical switch 230 may receive and route photons of state Ψ₀, while photons of state Ψ₁ are provided to, and routed by, optical switch 240. However, the optical switches may route photons of any desired states.

Optical switches 230, 240 are each configured to receive the separated components of an input 215 (e.g., a photon of state Ψ₀, a photon of state Ψ₁) on a same input port of the respective optical switch, and route the separated components (preferably in parallel) to the same output port of the respective optical switch. For example, an initial input QSC 225 may provide an individual separated component of an input 215 (e.g., a photon of state Ψ₀) to a first input port of optical switch 230 and another component of input 215 (e.g., a photon of state Ψ₁) to a first input port of optical switch 240. Optical switches 230, 240 each route the corresponding component to the same corresponding output port of that optical switch (e.g., optical switch 230 routes the photon of state Ψ₀ to its third output port, while optical switch 240 routes the photon of state Ψ₁ to its third output port, etc.).

Output QSCs 255 each receive the separated individual components of inputs 215 (e.g., photons of state Ψ₀, photons of state Ψ₁) from corresponding output ports of optical switches 230, 240, and produce the entangled photons (corresponding to the input) that are provided to a corresponding output 265 (e.g., outputs (Ψ₀/Ψ₁)_{1′}, (Ψ₀/Ψ₁)_{2′}, (Ψ₀/Ψ₁)_{3′}, (Ψ₀/Ψ₁)_{4′}, (Ψ₀/Ψ₁)_{5′}, (Ψ₀/Ψ₁)_{6′}, (Ψ₀/Ψ₁)_{7′}, and (Ψ₀/Ψ₁)_{8′'}as viewed in FIG. 2) for transference to fiber or other carrier. For example, each output QSC 255 may receive a photon of state Ψ₀ corresponding to an input 215 from an output port of optical switch 230 and a corresponding photon of state Ψ₁ corresponding to that same input from the same or different output port of optical switch 240. An output QSC 255 is a path-to-state converter that converts path (or optical) encoding compatible with optical switches 230, 240 to entangled states depending on the type of entanglement desired as described below. Thus, an input 215 (e.g., (Ψ₀/Ψ₁)₁) may be provided to a corresponding input QSC 225 that produces individual components (e.g., a photon of state Ψ₀, a photon of state Ψ₁). These components are routed by optical switches 230, 240 to a same desired output port of each optical switch. An output 265 is produced by a corresponding output QSC 255, thereby enabling an input 215 (e.g., (Ψ₀/Ψ₁)₁) to be routed to any desired output (e.g., (Ψ₀/Ψ₁)_{1′}, (Ψ₀/Ψ₁)_{2′}, (Ψ₀/Ψ₁)_{3′}, (Ψ₀/Ψ₁)_{4′}, (Ψ₀/Ψ₁)_{5′}, (Ψ₀/Ψ₁)_{6′}, (Ψ₀/Ψ₁)_{7′}, and (Ψ₀/Ψ₁)_{8′}) with the same entanglement state or a different entanglement state.

In an embodiment, output QSC 255 may convert between TE and TM modes for consistency and compatibility with the initial modes of the input or with modes of the fiber or other carrier (e.g., convert a separated component from TM mode to TE mode, convert a separated component from TE mode to TM mode, etc.).

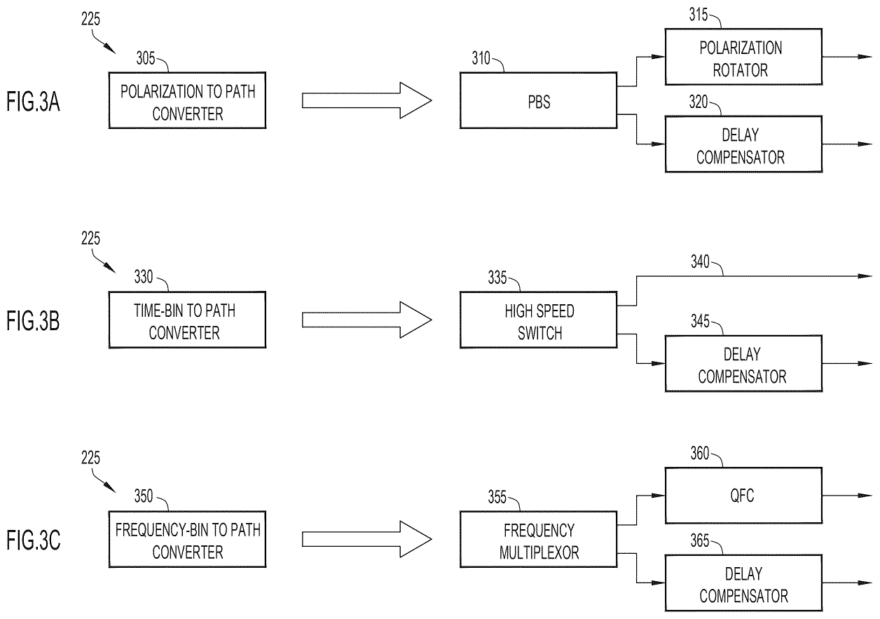

Input QSC 225 may perform polarization qubit conversion, time-bin qubit conversion, or frequency-bin qubit conversion. With continued reference to FIGS. 1 and 2, FIG. 3A illustrates an input QSC 225 for polarization qubit conversion, according to an example embodiment. Basically, polarization-entangled photons (or qubits) have the polarization state of one photon correlated with the polarization state of another photon. Input QSC 225 includes a polarization to path converter 305 including a polarizing beam splitter (PBS) 310, a polarization rotator 315, and a delay compensator 320. PBS 310 may be implemented by any conventional or other optical device that separates photons based on polarization (e.g., polarizing beam splitter, cube beam splitter, plate beam splitter, etc.). PBS 310 separates polarization-entangled photons of an input 215 based on H (Ψ₀) (horizontal) and V (Ψ₁) (vertical) polarization states. A photon of the V (Ψ₁) state (TM mode) from PBS 310 is rotated by polarization rotator 315 from a TM mode to a TE mode. The polarization rotator may be implemented by any conventional or other optical device for rotating a polarization axis of a light beam by an angle (e.g., Faraday rotator, etc.). A photon of the H (Ψ₀) (horizontal) state from PBS 310 is provided to delay compensator 320 to account for the delay of the conversion and provide the photons to corresponding optical switches 230, 240 at substantially the same time (or within a desired time interval). The delay compensator may be implemented by any conventional or other optical device providing a desired delay (e.g., fiber delay line or loop, etc.). The photon with an H (Ψ₀) state is sent through optical switch 230 for routing, while the photon with a V (Ψ₁) state is sent to optical switch 240 for routing. After the photons are routed to the appropriate output ports of optical switches 230, 240, a corresponding output QSC 255 receives the separated components from those output ports and produces entangled photons as a corresponding output 265 for transference to a connected output fiber or other carrier.

With continued reference to FIGS. 1, 2, and 3A, FIG. 3B illustrates an input QSC 225 for time-bin qubit conversion, according to an example embodiment. Basically, time-bin entangled photons (or qubits) are correlated based on a time difference of the photons (e.g., difference in time of traversals of different paths by the photons in an interferometer). Input QSC 225 includes a time-bin to path converter 330 including a high speed switch 335, and a delay compensator 345. High speed switch 335 may be implemented by any conventional or other optical switch. By way of example, high speed switch 335 may be implemented by a high-speed electro-optic modulator embedded in a Mach Zehnder interferometer (MZI). However, various other modulator types may be employed (e.g., thermo-optic, photonic micro-electromechanical systems (MEMS), magneto-optic, etc.). High speed switch 335 separates time-bin entangled photons of an input 215 into a photon of an early time bin (Ψ₀) and a photon of a late time bin (Ψ1)₁. The high speed switch provides (or switches) the photon of the late time bin to a through port 340. The photon of the early time bin is provided (or switched) by high speed switch 335 to delay compensator 345 to account for the delay between the time bins and provide the photons to corresponding optical switches 230, 240 at substantially the same time (or within a desired time interval). The delay compensator may be implemented by any conventional or other optical device providing a desired delay (e.g., fiber delay line or loop, etc.). The photon of the early time bin (Ψ₀) is sent through optical switch 230 for routing, while the photon of the late time bin (Ψ₁) is sent to optical switch 240 for routing. After the photons are routed to the appropriate output ports of optical switches 230, 240, a corresponding output QSC 255 receives the separated components from those output ports and produces entangled photons as a corresponding output 265 for transference to a connected output fiber or other carrier.

With continued reference to FIGS. 1, 2, 3A, and 3B, FIG. 3C illustrates an input QSC 225 for frequency-bin qubit conversion, according to an example embodiment. Basically, frequency-bin entangled photons (or qubits) have a frequency bin (or frequency range) of a signal photon correlated with a frequency bin (or frequency range) of an idler photon. Input QSC 225 includes a frequency-bin to path converter 350 including a frequency demultiplexer 355, a quantum frequency converter (QFC) 360, and a delay compensator 365. Frequency demultiplexer 355 may be implemented by any conventional or other optical device for dividing light into frequencies (e.g., wavelength division demultiplexer, add-drop ring resonator, etc.). By way of example, frequency demultiplexer 355 may be implemented by an add-drop ring resonator that separates frequency-bin entangled photons of an input 215 into a photon of a low frequency (Ψ₀) and a photon of a high frequency (Ψ₁). Frequency demultiplexer 355 downloads the low frequency (Ψ₀) state to a drop port of the add-drop resonator that is coupled to QFC 360. QFC 360 may be implemented by any conventional or other device that transfers quantum states between frequencies, and shifts the photon of the low frequency state toward a frequency compatible with optical switch 230. The photon of the high frequency state (Ψ₁) is provided to delay compensator 365 to account for the delay (of the frequency conversion) and provide the photons to corresponding optical switches 230, 240 at substantially the same time (or within a desired time interval). The delay compensator may be implemented by any conventional or other optical device providing a desired delay (e.g., fiber delay line or loop, etc.). The photon of the low frequency state (Ψ₀) is sent through optical switch 230 for routing, while the photon of the high frequency state (Ψ₁) is sent to optical switch 240 for routing. After the photons are routed to the appropriate output ports of optical switches 230, 240, a corresponding output QSC 255 receives the separated components from those output ports and produces entangled photons as a corresponding output 265 for transference to a connected output fiber or other carrier.

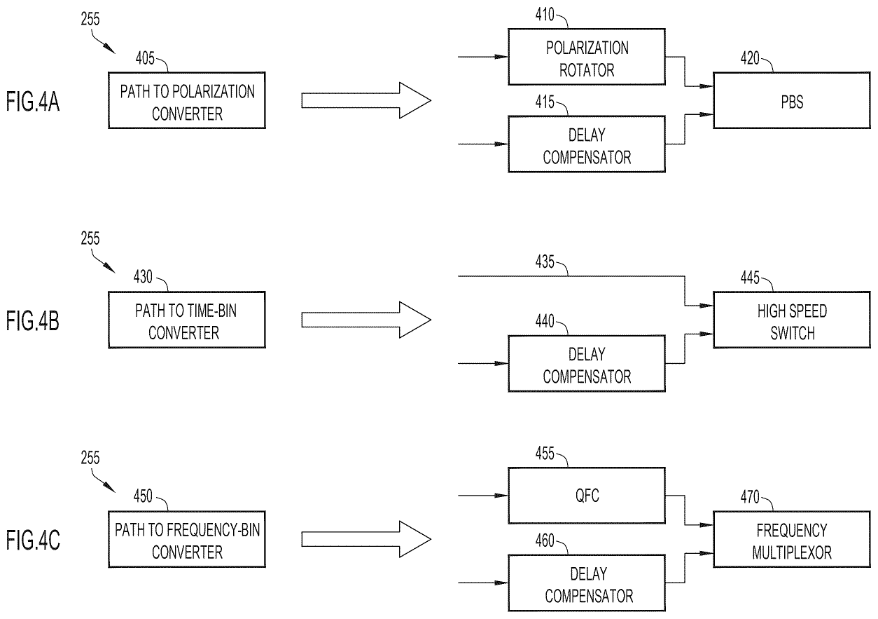

Output QSC 255 may similarly perform polarization qubit conversion, time-bin qubit conversion, or frequency-bin qubit conversion. With continued reference to FIGS. 1, 2, 3A, 3B, and 3C, FIG. 4A illustrates an output QCS 255 for polarization qubit conversion, according to an example embodiment. Output QSC 255 includes a path to polarization converter 405 including a polarization rotator 410, a delay compensator 415, and a polarizing beam splitter (PBS) 420. A photon of the V (Ψ₁) (vertical) state corresponding to an input 215 (converted to TE mode as described above) is obtained from an output port of optical switch 240 after routing, and rotated by polarization rotator 410 from the TE mode back to the TM mode. The polarization rotator may be implemented by any conventional or other optical device for rotating a polarization axis of a light beam by an angle (e.g., Faraday rotator, etc.). A photon of the H (Ψ₀) (horizontal) state corresponding to input 215 is obtained from a corresponding output port of optical switch 230 after routing, and provided to delay compensator 415 to account for the delay of the conversion. The delay compensator may be implemented by any conventional or other optical device providing a desired delay (e.g., fiber delay line or loop, etc.). The photons are provided to PBS 420 at substantially the same time (or within a desired time interval). PBS 420 may be implemented by any conventional or other optical device that combines light beams (e.g., polarizing beam splitter, cube beam splitter, plate beam splitter, etc.). PBS 420 receives the photons from polarization rotator 410 and delay compensator 415, and produces polarization-entangled photons (corresponding to input 215) that are provided as a corresponding output 265 for transference to a connected output fiber or other carrier.

With continued reference to FIGS. 1, 2, 3A, 3B, 3C, and 4A, FIG. 4B illustrates an output QSC 255 for time-bin qubit conversion, according to an example embodiment. Output QSC 255 includes a path to time-bin converter 430 including a delay compensator 440 and a high speed switch 445. The photon corresponding to the early time bin (Ψ₀) of an input 215 is obtained from an output port of optical switch 230 after routing, and placed on a through port 435. The photon corresponding to the late time bin (Ψ₁) of input 215 is obtained from a corresponding output port of optical switch 240 after routing, and provided to delay compensator 440. Since the photons of the early and late time bins are routed and available from optical switches 230, 240 at substantially the same time, the delay compensator provides a delay to arrange the photons back in early and late time bins corresponding to input 215. The delay compensator may be implemented by any conventional or other optical device providing a desired delay (e.g., fiber delay line or loop, etc.). The photons of the early and late time bins are provided to high speed switch 445 to produce time-bin entangled photons. High speed switch 445 may be implemented by any conventional or other optical switch. By way of example, high speed switch 445 may be implemented by a high-speed electro-optic modulator embedded in a Mach Zehnder interferometer (MZI). However, various other modulator types may be employed (e.g., thermo-optic, photonic micro-electromechanical systems (MEMS), magneto-optic, etc.). High speed switch 445 receives the photons corresponding to input 215 (e.g., a photon of an early time bin (Ψ₀) and a photon of a late time bin (Ψ₁)) from through port 435 and delay compensator 440, and produces time-bin entangled photons (corresponding to input 215) as a corresponding output 265 for transference to a connected output fiber or other carrier.

With continued reference to FIGS. 1, 2, 3A, 3B, 3C, 4A, and 4B, FIG. 4C illustrates an output QSC 255 for frequency-bin qubit conversion, according to an example embodiment. Output QSC 255 includes a path to frequency-bin converter 450 including a quantum frequency converter (QFC) 455, a delay compensator 460, and a frequency multiplexer 470. The photon corresponding to the low frequency state (Ψ₀) of an input 215 is obtained from an output port of optical switch 230 after routing, and provided to QFC 455. QFC 455 may be implemented by any conventional or other device that transfers quantum states between frequencies. Since the frequency of the photon in the low frequency state had been shifted as described above, QFC 455 shifts the photon corresponding to the low frequency state back toward its original frequency (to restore the low frequency state). The photon corresponding to the high frequency state (Ψ₁) of input 215 is obtained from a corresponding output port of optical switch 240 after routing, and provided to delay compensator 460 to account for the delay of the conversion. The delay compensator may be implemented by any conventional or other optical device providing a desired delay (e.g., fiber delay line or loop, etc.). Frequency multiplexer 470 may be implemented by any conventional or other optical device for combining frequencies (e.g., wavelength division multiplexer, etc.). Frequency multiplexer 470 receives the photons corresponding to input 215 (e.g., a photon of a low frequency state (Ψ₀) and a photon of a high frequency state (Ψ₁)) from QFC 455 and delay compensator 460, and produces frequency-bin entangled photons (corresponding to input 215) as a corresponding output 265 for transference to a connected output fiber or other carrier.

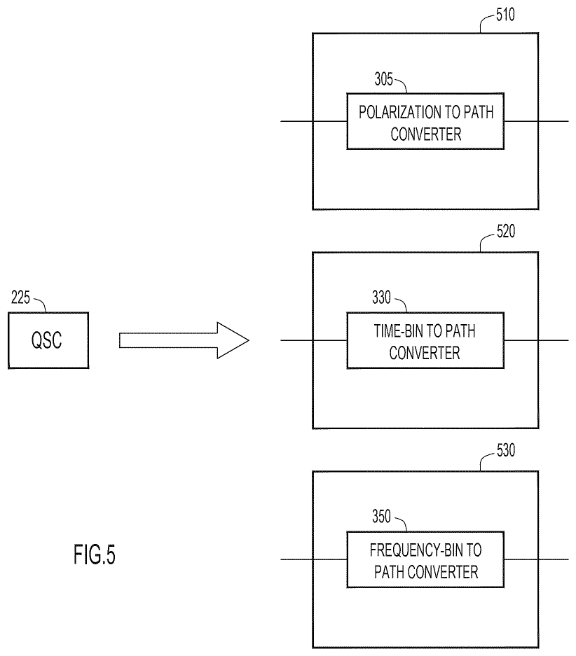

Separate modules for entanglement may serve as an interface between fiber and photonic quantum switch 200. With continued reference to FIGS. 1, 2, 3A, 3B, 3C, 4A, 4B, and 4C, FIG. 5 illustrates pluggable modules for input quantum state converters (QSCs), according to an example embodiment. Initially, input QSCs 225 and output QSCs 255 may perform polarization qubit conversion, time-bin qubit conversion, or frequency-bin qubit conversion as described above. The input and output QSCs may be in the form of pluggable modules. For example, a pluggable input polarization module 510 may include polarization to path converter 305 as described above for an input QSC 225 for polarization qubit conversion, while a pluggable input time-bin module 520 may include time-bin to path converter 330 as described above for an input QSC 225 for time-bin qubit conversion. In addition, a pluggable input frequency-bin module 530 may include frequency-bin to path converter 350 as described above for an input QSC 225 for frequency-bin qubit conversion. Users may select a module 510, 520, 530 to utilize (or plug in) for photonic quantum switch 200 based on the type of entanglement. The modules serve as input QSCs 225 for photonic quantum switch 200 (FIG. 2).

In addition, pluggable modules may be used for output QSCs 255 in substantially the same manner described above. For example, an output polarization module may include path to polarization converter 405 as described above for an output QSC 255 for polarization qubit conversion, while a pluggable output time-bin module may include path to time-bin converter 430 as described above for an output QSC 255 for time-bin qubit conversion. In addition, a pluggable output frequency-bin module may include path to frequency-bin converter 450 as described above for an output QSC 255 for frequency-bin qubit conversion. Users may select a pluggable output module to utilize (or plug in) for photonic quantum switch 200 based on the type of entanglement. The modules serve as output QSCs 255 for photonic quantum switch 200 (FIG. 2). Thus, the photonic quantum switch may be reconfigurable to accommodate different types of input and output entanglement states.

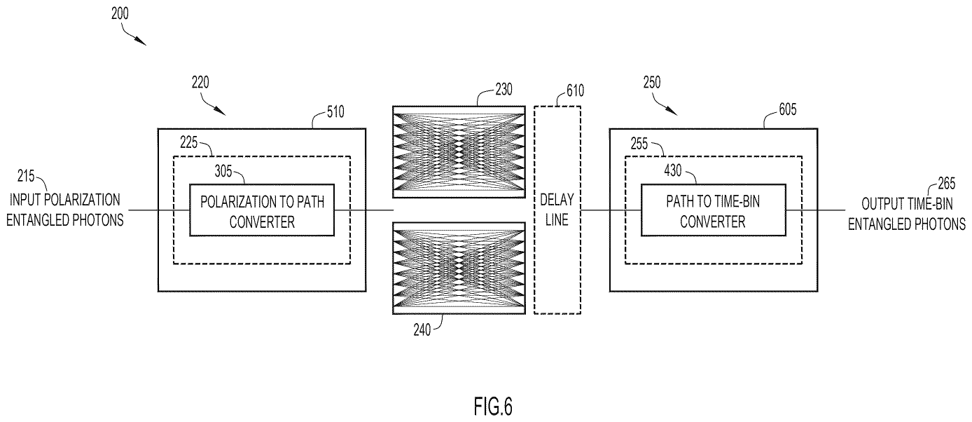

With continued reference to FIGS. 1, 2, 3A, 3B, 3C, 4A, 4B, 4C, and 5, FIG. 6 illustrates a block diagram of performing entanglement conversion using photonic quantum switch 200, according to an example embodiment. By way of example, FIG. 6 illustrates converting polarization-entangled qubits to time-bin entangled qubits. However, photonic quantum switch 200 may be used to convert between other types of entanglements in substantially the same manner described below.

Photonic quantum switch 200 includes series 220 of input quantum state converters (QSC) 225, optical switches 230, 240 coupled to input QSCs 225, and series 250 of output quantum state converters (QSC) 255 coupled to optical switches 230, 240 arranged in substantially the same manner described above. Photonic quantum switch 200 receives inputs 215 that are entangled photons representing qubits as described above. In this example case, input QSCs 225 include pluggable input polarization modules 510 that include polarization to path converter 305 as described above for polarization qubit conversion. Output QSCs 255 include pluggable output time-bin modules 605 that include path to time-bin converter 430 described above for time-bin qubit conversion.

Inputs 215 include photons that are polarization-entangled. The photons are provided to polarization to path converter 305 of pluggable input polarization module 510. Polarization to path converter 305 separates the polarization-entangled photons based on H (Ψ₀) (horizontal) and V (Ψ₁) (vertical) polarization states in substantially the same manner described above. A photon of the V (Ψ₁) state (TM mode) may be rotated from a TM mode to a TE mode in substantially the same manner described above. The photon with an H (Ψ₀) state is sent through optical switch 230 for routing, while the photon with a V (Ψ₁) state is sent to optical switch 240 for routing in substantially the same manner described above. A switchable delay line 610 may be disposed between optical switches 230, 240 and output QSCs 255 to remove a time difference between paths from the optical switches. The switchable delay line may be implemented by any conventional or other optical delay devices (e.g., a spiral waveguide with thermo-optic time delay for temporal fine tuning, where a heater above the spiral waveguide can be used to finely tune the delay if there are any small variations between the devices).

Optical switches 230, 240 route the photons to corresponding output ports of those switches in substantially the same manner described above. The photons are provided from the output ports of the optical switches to path to time-bin converter 430 of pluggable output time-bin module 605. By way of example, path to time-bin converter 430 considers photons from optical switch 230 to correspond to the early time bins (Ψ₀) and photons from optical switch 240 to correspond to the late time bins (Ψ₁). However, photons from optical switches 230, 240 can be considered to correspond to any state. Path to time-bin converter 430 receives the photons corresponding to input 215 (e.g., a photon of an early time bin (Ψ₀) and a photon of a late time bin (Ψ₁)), and produces time-bin entangled photons (corresponding to input 215) as a corresponding output 265 for transference to a connected output fiber or other carrier.

Photonic quantum switch 200 may be configured to perform various other entanglement conversions (between different types of entanglement) based on the pluggable modules employed. Thus, the photonic quantum switch may be configurable to accommodate different types of entanglement conversions. For example, pluggable input polarization module 510 of input QSCs 225 may be utilized with pluggable output time-bin module 605 for output QSCs 255 to convert between polarization entanglement and time-bin entanglement. Similarly, pluggable input polarization module 510 of input QSCs 225 may be utilized with a pluggable output frequency-bin module (including path to frequency-bin converter 450) for output QSCs 255 to convert between polarization entanglement and frequency-bin entanglement.

Further, pluggable input time-bin module 520 of input QSCs 225 may be utilized with a pluggable output polarization module (including path to polarization converter 405) for output QSCs 255 to convert between time-bin entanglement and polarization entanglement. Similarly, pluggable input time-bin module 520 of input QSCs 225 may be utilized with a pluggable output frequency-bin module (including path to frequency-bin converter 450) for output QSCs 255 to convert between time-bin entanglement and frequency-bin entanglement.

In addition, pluggable input frequency-bin module 530 of input QSCs 225 may be utilized with a pluggable output polarization module (including path to polarization converter 405) for output QSCs 255 to convert between frequency-bin entanglement and polarization entanglement. Similarly, pluggable input frequency-bin module 530 of input QSCs 225 may be utilized with a pluggable output time-bin module (including path to time-bin converter 430) for output QSCs 255 to convert between frequency-bin entanglement and time-bin entanglement.

Optical switches 230, 240 may be within the same or different switches. The conversion from and to frequency-bin qubits requires a quantum frequency converter (QFC) (e.g., besides a delay line, an additional QFC component is added). This can be accomplished with a properly designed single-sideband electro-optic modulator to converter that is enabled when one of the frequency bin states arrives at the modulator to shift the frequency higher (or lower), and then disabled when the other frequency bin state arrives so that its frequency remains unchanged. Frequencies required for this can be on the order of 10-20 GHz (well within existing modulator technology bandwidth).

An example embodiment may be developed in different pathways. For example, in a homogeneous pathway, a photonic integrated circuit (PIC) material is chosen, such as SiN, that is transparent down to 493 nm. Switch PICs are developed that are optimized for each wavelength (e.g. one SiN PIC for 493, one SiN PIC for 780 nm, one SiN for 1550 nm, etc.). These could then be packaged as individual chips into a single Q-Switch module (e.g., not all switches on one PIC, but package together multiple PICs). This approach is lowest risk since a single PIC material platform is used, and SiN can be fabricated at a foundry at large scale.

The switching speed for the homogenous pathway is limited by thermo-optic tuning to ~10 kHz at all wavelengths. Each PIC can be optimized for that specific wavelength.

By way of further example, in a heterogeneous pathway, each PIC switch is optimized for the specific wavelength. For example, at O, C, and L bands, silicon on insulator (SOI) can be used with electro-optic switching for GHz speeds, and fabricated at a foundry. For visible and Near Infrared (NIR), various materials (e.g., SiN, aluminum nitride, gallium nitride, silicon carbide, ferroelectric nitrides (like scandium aluminum nitride), ferroelectric oxides (like lithium niobate), etc.) may be fabricated at a foundry with thermo-optic switching at kHz speed.

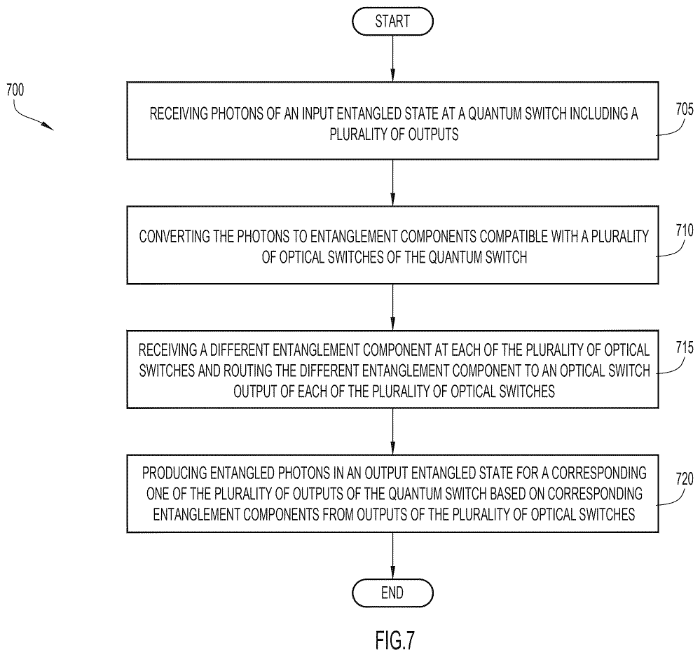

FIG. 7 illustrates a flowchart of a generalized method 700 for switching entangled photons in a photonic quantum switch, according to an example embodiment. At operation 705, photons of an input entangled state are received at a quantum switch including a plurality of outputs. At operation 710, the photons are converted to entanglement components compatible with a plurality of optical switches of the quantum switch. At operation 715, a different entanglement component is received at each of the plurality of optical switches and the different entanglement component is routed to an optical switch output of each of the plurality of optical switches. At operation 720, entangled photons in an output entangled state are produced for a corresponding one of the plurality of outputs of the quantum switch based on corresponding entanglement components from outputs of the plurality of optical switches.

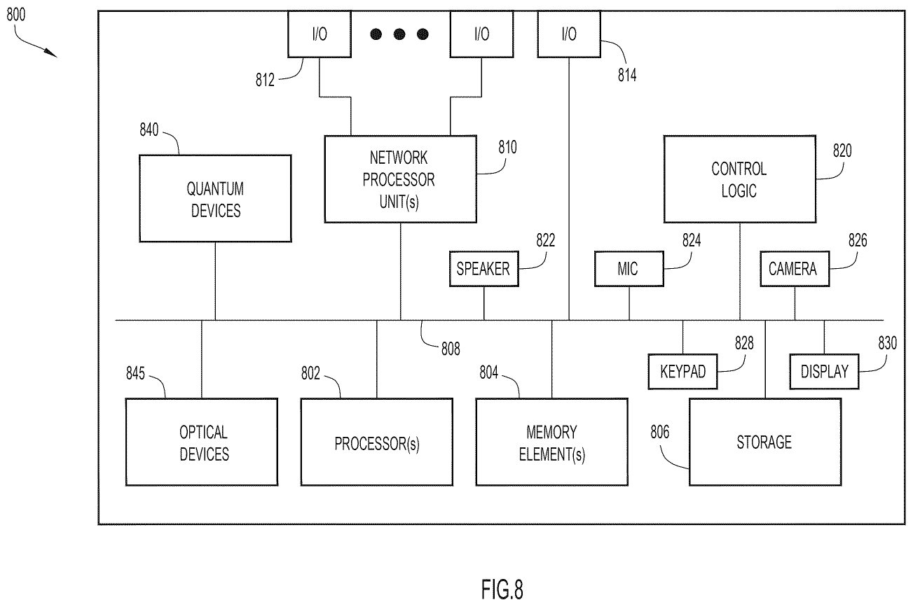

Referring to FIG. 8, FIG. 8 illustrates a hardware block diagram of a computing device 800 that may perform functions associated with operations discussed herein in connection with the techniques depicted in FIGS. 1, 2, 3A, 3B, 3C, 4A, 4B, 4C, and 5-7. In various embodiments, a computing device or apparatus or system, such as computing device 800 or any combination of computing devices 800, may be configured as any device entity/entities (e.g., network nodes, computer devices, user devices, client devices, communication devices, network devices, processors, switching devices, network interfaces, controller, quantum nodes, programmable control and measurement unit 135, quantum processors, etc.) as discussed for the techniques depicted in connection with FIGS. 1, 2, 3A, 3B, 3C, 4A, 4B, 4C, and 5-7 in order to perform operations of the various techniques discussed herein.

In at least one embodiment, computing device 800 may be any apparatus that may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory elements 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interfaces 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, network device, network nodes, processors, network interfaces, switching devices, quantum nodes, etc.), computing device 800 may further include, or be coupled to, a speaker 822 to convey sound, microphone or other sound sensing device 824, camera or image capture device 826, a keypad or keyboard 828 to enter information (e.g., alphanumeric information, etc.), a touch screen or other display 830, quantum devices 840, and/or optical devices 845. These items may be coupled to bus 808 or I/O interface(s) 814 to transfer data with other elements of computing device 800. Quantum devices 840 may include any conventional or other devices to perform the functions described herein (e.g., generating, transmitting, receiving, entangling, and/or processing quantum signals and/or keys), such as a quantum source, quantum transmitters and receivers, quantum channels, a source of randomness, lasers or other energy sources, quantum measuring devices, quantum logic or other gates or circuits, quantum memories, quantum processing units, quantum buffers, switches, etc. Optical devices 845 may include any conventional or other optical devices to perform the functions described herein (e.g., generating, transmitting, receiving, and/or processing classical or other optical signals), such as optical switches, optical transmitters and receivers, optical multiplexers or other switching devices, etc.

In various embodiments, control logic 820 can include instructions that, when executed, cause processor(s) 802 to perform operations, which can include, but not be limited to, providing overall control operations of computing device 800; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory elements 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features (of a method, system, and/or apparatus). However, all disclosed example embodiments are designed to work together as part of a single larger system, method, or apparatus. This disclosure explicitly envisions compound embodiments that combine multiple previously-discussed features in different example embodiments into a single system, method, or apparatus.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: receiving photons of an input entangled state at a quantum switch including a plurality of outputs; converting the photons to entanglement components compatible with a plurality of optical switches of the quantum switch; receiving a different entanglement component at each of the plurality of optical switches and routing the different entanglement component to an optical switch output of each of the plurality of optical switches; and producing entangled photons in an output entangled state for a corresponding one of the plurality of outputs of the quantum switch based on corresponding entanglement components from outputs of the plurality of optical switches

In one example, the input entangled state includes a polarization entangled state, and the entanglement components include a photon with horizontal polarization and a photon with vertical polarization.

In one example, the input entangled state includes a time-bin entangled state, and the entanglement components include a photon of an early time bin and a photon of a late time bin.

In one example, the input entangled state includes a frequency-bin entangled state, and the entanglement components include a photon of a low frequency state and a photon of a high frequency state.

In one example, the output entangled state is different than the input entangled state to convert the photons from the input entangled state to the output entangled state.

In one example, the input entangled state includes a polarization entangled state, and the output entangled state includes one of a time-bin entangled state and a frequency-bin entangled state.

In one example, the input entangled state includes a time-bin entangled state, and the output entangled state includes one of a polarization entangled state and a frequency-bin entangled state.

In one example, the input entangled state includes a frequency-bin entangled state, and the output entangled state includes one of a polarization entangled state and a time-bin entangled state.

In one example, the plurality of optical switches are arranged in parallel.

In one example, the method further comprises reconfiguring the quantum switch with pluggable modules accommodating different input entangled states and different output entangled states.

In another form, an apparatus is provided. The apparatus comprises: a plurality of outputs and an input to receive photons of an input entangled state; a first converter to convert the photons to entanglement components; a plurality of optical switches each receiving a different entanglement component and routing the different entanglement component to an optical switch output, wherein the entanglement components from the first converter are compatible with the plurality of optical switches; and a second converter to produce entangled photons in an output entangled state for a corresponding one of the plurality of outputs based on corresponding entanglement components from outputs of the plurality of optical switches.

In yet another form, an apparatus is provided. The apparatus comprises: a first converter to convert photons to entanglement components, wherein the photons are in an input entangled state including one of a polarization entangled state, a time-bin entangled state, and a frequency-bin entangled state; a plurality of optical switches each receiving a different entanglement component and routing the different entanglement component to an optical switch output, wherein the entanglement components from the first converter are compatible with the plurality of optical switches; and a second converter to produce entangled photons in an output entangled state based on corresponding entanglement components from outputs of the plurality of optical switches, wherein the output entangled state includes one of a polarization entangled state, a time-bin entangled state, and a frequency-bin entangled state.

The description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
receiving photons of an input entangled state at a quantum switch including a plurality of outputs;
converting the photons to entanglement components compatible with a plurality of optical switches of the quantum switch;
receiving a different entanglement component at each of the plurality of optical switches and routing the different entanglement component to an optical switch output of each of the plurality of optical switches; and
producing entangled photons in an output entangled state for a corresponding one of the plurality of outputs of the quantum switch based on corresponding entanglement components from outputs of the plurality of optical switches.

2. The method of claim 1, wherein the input entangled state includes a polarization entangled state, and the entanglement components include a photon with horizontal polarization and a photon with vertical polarization.

3. The method of claim 1, wherein the input entangled state includes a time-bin entangled state, and the entanglement components include a photon of an early time bin and a photon of a late time bin.

4. The method of claim 1, wherein the input entangled state includes a frequency-bin entangled state, and the entanglement components include a photon of a low frequency state and a photon of a high frequency state.

5. The method of claim 1, wherein the output entangled state is different than the input entangled state to convert the photons from the input entangled state to the output entangled state.

6. The method of claim 2, wherein the output entangled state includes one of a time-bin entangled state and a frequency-bin entangled state.

7. The method of claim 3, wherein the output entangled state includes one of a polarization entangled state and a frequency-bin entangled state.

8. The method of claim 4, wherein the output entangled state includes one of a polarization entangled state and a time-bin entangled state.

9. The method of claim 1, wherein the plurality of optical switches are arranged in parallel.

10. The method of claim 1, further comprising:
reconfiguring the quantum switch with pluggable modules accommodating different input entangled states and different output entangled states.

11. An apparatus comprising:
a plurality of outputs and an input to receive photons of an input entangled state;
a first converter to convert the photons to entanglement components;
a plurality of optical switches each receiving a different entanglement component and routing the different entanglement component to an optical switch output, wherein the entanglement components from the first converter are compatible with the plurality of optical switches; and
a second converter to produce entangled photons in an output entangled state for a corresponding one of the plurality of outputs based on corresponding entanglement components from outputs of the plurality of optical switches.

12. The apparatus of claim 11, wherein the input entangled state includes a polarization entangled state, and the entanglement components include a photon with horizontal polarization and a photon with vertical polarization.

13. The apparatus of claim 11, wherein the input entangled state includes a time-bin entangled state, and the entanglement components include a photon of an early time bin and a photon of a late time bin.

14. The apparatus of claim 11, wherein the input entangled state includes a frequency-bin entangled state, and the entanglement components include a photon of a low frequency state and a photon of a high frequency state.

15. The apparatus of claim 11, wherein the output entangled state is different than the input entangled state to convert the photons from the input entangled state to the output entangled state.

16. The apparatus of claim 12, wherein the output entangled state includes one of a time-bin entangled state and a frequency-bin entangled state.

17. The apparatus of claim 13, wherein the output entangled state includes one of a polarization entangled state and a frequency-bin entangled state.

18. The apparatus of claim 14, wherein the output entangled state includes one of a polarization entangled state and a time-bin entangled state.

19. The apparatus of claim 11, wherein the plurality of optical switches are arranged in parallel.

20. The apparatus of claim 11, further comprising:
pluggable modules to accommodate different input entangled states and different output entangled states.

21. An apparatus comprising:
a first converter to convert photons to entanglement components, wherein the photons are in an input entangled state including one of a polarization entangled state, a time-bin entangled state, and a frequency-bin entangled state;
a plurality of optical switches each receiving a different entanglement component and routing the different entanglement component to an optical switch output, wherein the entanglement components from the first converter are compatible with the plurality of optical switches; and
a second converter to produce entangled photons in an output entangled state based on corresponding entanglement components from outputs of the plurality of optical switches, wherein the output entangled state includes one of a polarization entangled state, a time-bin entangled state, and a frequency-bin entangled state.

22. The apparatus of claim 21, wherein the output entangled state is a same entanglement state as the input entangled state.

23. The apparatus of claim 21, wherein the output entangled state is different than the input entangled state to convert the photons from the input entangled state to the output entangled state.
